(19) United States
(12) Patent Application Publication
(10) Pub. No.: US 2010/0257035 A1
(43) Pub. Date: Oct. 7, 2010

(54) EMBEDDED CONTENT BROKERING AND ADVERTISEMENT SELECTION DELEGATION

(75) Inventors: Kfir Karmon, Tel Aviv (IL); Roy Varshavsky, Tel Aviv (IL); Ron Karidi, Herzeliya (IL); Hen Fitoussi, Tel Aviv (IL); Liza Fireman, Atlit (IL)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/419,322

(22) Filed: Apr. 7, 2009

(51) Int. Cl. G06Q 30/00; G06F 15/16

(52) U.S. Cl. 705/14.11; 709/203

(57) ABSTRACT

A digital document request can be received at a publisher computing environment from a client computing environment. A document requested by the digital document request can include an embedded content placeholder. A third-party embedded content request can be sent from a content broker computing environment (which may be the same as or different from the publisher computing environment) to an embedded content provider computing environment to request content for the embedded content placeholder. Content corresponding to the third-party embedded content request can be received at the content broker computing environment. In addition, the digital document can be sent from the publisher computing environment to the client computing environment, and the content can be sent from the content broker computing environment to the client computing environment. Advertisement selection can also be delegated to an advertisement selection delegate computing environment.

### BACKGROUND

Many users spend a great deal of time interacting with others over computer networks, and often over global communications networks such as the Internet. In doing so, users can engage in many interactions that indicate their personal interests, especially when conducting searches. Furthermore, users' online behavior can allow others to personally identify them by analyzing server side records, without users' consent or knowledge. This can create privacy concerns, which can be amplified when an ad network or other embedded content provider, which provides embedded content for a plethora of websites, collects data about users from all affiliate sites, and can extract personal identifiable information and other information that users of these sites would not want revealed. Further yet, this information may be combined with search information to uncover users' specific interests and intent, along with their online behavior patterns.

### SUMMARY

Whatever the advantages of previous privacy protection tools and techniques, they have neither recognized the privacy protection tools and techniques described and claimed herein, nor the advantages produced by such tools and techniques.

In one embodiment, the tools and techniques can include receiving at a publisher computing environment a digital document request from a client computing environment. The digital document request can list an address associated with the publisher computing environment as a final destination. A document requested by the digital document request can include an embedded content placeholder. A third-party embedded content request can be sent from the publisher computing environment to an embedded content provider computing environment to request content for the embedded content placeholder. Content corresponding to the third-party embedded content request can be received at the publisher computing environment. In addition, the digital document and the content can be sent from the publisher computing environment to the client computing environment.

In another embodiment of the tools and techniques, a digital document can be received at a client computing environment. Also at the client computing environment, a content broker computing environment can be selected from a plurality of available content broker computing environments. Each of the available content broker computing environments can be configured to receive client embedded content requests, send broker embedded content requests to an embedded content provider computing environment in response to the client embedded content requests, and receive content requested by the third-party embedded content requests. A client embedded content request can be sent from the client computing environment to the selected content broker computing environment. In addition, content requested in the client embedded content request can be received from the selected content broker computing environment. The content requested in the client embedded content request can also be rendered along with the digital document on a display at the client computing environment.

In yet another embodiment of the tools and techniques, user input selecting a displayed digital advertisement can be received. A client advertisement selection message can be sent to an advertisement selection delegate computing environment. The advertisement selection delegate computing environment can be configured to receive client advertisement selection messages, forward corresponding delegate advertisement selection messages to an advertisement redirector computing environment, and receive from the advertisement redirector computing environment redirect messages corresponding to the delegate advertisement selection messages. A redirect message can be received from the advertisement selection delegate computing environment in response to the client advertisement selection message. The redirect message can include an address indicator corresponding to an advertiser computing environment. An advertiser document request can be sent to the advertiser computing environment in response to receiving the redirect message, with the advertiser document request not being addressed to the advertisement selection delegate computing environment. In addition, a digital advertiser document corresponding to the advertiser document request can be received.

This Summary is provided to introduce a selection of concepts in a simplified form. The concepts are further described below in the Detailed Description. This Summary is not intended to identify key features or essential features of the claimed subject matter, nor is it intended to be used to limit the scope of the claimed subject matter. Similarly, the invention is not limited to implementations that address the particular techniques, tools, environments, disadvantages, or advantages discussed in the Background, the Detailed Description, or the attached drawings.

### BRIEF DESCRIPTION OF THE DRAWINGS

FIG. 1 is a block diagram of a suitable computing environment in which one or more of the described embodiments may be implemented.

FIG. 2 is block diagram illustrating an embedded content brokering system and technique.

FIG. 3 is a block diagram illustrating another embedded content brokering system and technique.

FIG. 4 is a block diagram illustrating yet another embedded content brokering system and technique.

FIG. 5 is a block diagram illustrating an advertisement selection delegation system and technique.

FIG. 6 is a schematic diagram illustrating a system for generating and maintaining a user profile in a client environment.

FIG. 7 is a flow diagram of a content brokering technique.

FIG. 8 is a flow diagram of another content brokering technique.

FIG. 9 is a flow diagram of yet another content brokering technique.

FIG. 10 is a flow diagram of yet another content brokering technique.

FIG. 11 is a flow diagram of an advertisement selection delegation technique.

### DETAILED DESCRIPTION

Described embodiments are directed to techniques and tools for improved privacy protection, such as improved privacy protection for users who are interacting with embedded content providers. Such improvements may result from the use of various techniques and tools separately or in combination.

Such techniques and tools may include sending a request from a client computing environment for a digital document. As used herein, the term digital document broadly refers to digital data and/or code (such as one or more digital files or packets), which can be rendered on a display in a client computing environment. Embedded content refers to content that can be embedded within such a digital document (i.e., rendered as part of the digital document). For example, the client computing environment can send a client digital document request (such as an HTTP get message) to a digital document provider computing environment, such as a web publisher computing environment. The digital document provider or publisher computing environment can send the digital document back to the client computing environment, such as by including the page in an HTTP message.

The digital document can include an embedded content placeholder for embedded content. Such a place holder can take many different forms, but it indicates that some content, such as one or more digital advertisements or one or more digital audio or video files, is expected to be embedded in the digital document (i.e., rendered as part of the digital document). The placeholder can include a script, which can be run on the client computing environment to send an embedded content request, such as a request for advertisements. The embedded content request can be an HTTP get message, and it can be sent to a content broker computing environment (which can be the same as the digital document provider computing environment in some implementations). In some implementations, the client computing environment may select a content broker computing environment from multiple available content broker computing environments.

In response to the embedded content request from the client, the content broker computing environment can send an embedded content request to an embedded content provider computing environment, such as an advertisement content provider (e.g., ad networks such as Microsoft AdCenter, Google AdSense, etc.) or an audio-visual embedded content provider (e.g., YouTube). The broker computing environment can remove from the embedded content request identifying information corresponding to the client computing environment (which can be information associated with the client computing environment itself or one or more users of the client computing environment). In response to the embedded content request, the embedded content provider can send the requested embedded content (e.g., digital advertisements, digital video files, etc.) to the broker computing environment, and the broker computing environment can send the requested embedded content to the client computing environment.

For some types of content, such as advertisements, a user on the client computing environment may provide user input to select at least a portion of the embedded content, such as the advertisements on a web page. When that happens, the user's client computing environment can send a client advertisement selection message (e.g., an HTTP get message) to an advertisement selection delegate computing environment, which may be the same as the broker computing environment in some implementations. The advertisement selection delegate computing environment can remove from the client advertisement selection message identifying information associated with the client computing environment. The advertisement selection delegate computing environment can forward a delegate advertisement selection message to an advertiser redirector computing environment, which may be the same as the embedded content provider computing environment. The advertiser redirector computing environment can send a redirect message back to the client computing environment. The client computing environment can use an address or address indicator, such as a URL, in the redirect message to send an advertiser document request (e.g., an HTTP get message) to an advertiser computing environment. The advertiser document request can be addressed and sent directly to the advertiser computing environment, rather than the request being addressed or sent to the advertisement selection delegate computing environment. The advertiser computing environment can then send a requested advertiser document, such as a web page, back to the client computing environment.

In existing systems, when a user requests a digital document such as a web page, the client computing environment sends a get page request (such as an HTTP get message) to a digital document provider computing environment, such as a web publisher computing environment. The web publisher computing environment can send the digital document back to the client computing environment, such as by including the page in an HTTP message.

In such existing systems, the digital document can include a placeholder for embedded content, such as one or more digital advertisements. The placeholder can include a script, which can be run on the client computing environment to send an embedded content request, such as a request for advertisements. The embedded content request can be an HTTP get message, and it can be sent to an embedded content provider computing environment, such as an advertisement content provider (e.g., ad networks such as Microsoft, Google, etc.) or an audio-visual embedded content provider (e.g., YouTube). In response to the embedded content request, the embedded content provider typically sends the requested embedded content (e.g., digital advertisements, digital video files, etc.) to the client computing environment.

In the case of advertisements, in existing schemes a user may select an embedded advertisement displayed on a web page. When that happens, the user's client computing environment typically sends an advertiser document request (e.g., an HTTP get message) to an advertiser redirector computing environment, which is typically the same as the embedded content provider computing environment. The advertiser redirector computing environment then sends a redirect message back to the client computing environment. The client computing environment can use an address indicator, such as a URL, in the redirect message to send an advertiser document request (e.g., an HTTP get message) to an advertiser computing environment. The advertiser computing environment can then send a requested advertiser document, such as a web page, back to the client computing environment.

Most existing schemes to protect users' privacy from ad networks or other embedded content providers or redirector environments are based on the opt-in or opt-out models. For an opt-in model, the default is that the user does not get tracked, and the user needs to explicitly opt in to be tracked and provided personalized content from the embedded content provider or redirector environment. For an opt-out model, the default is that the user does get tracked, and the user needs to explicitly opt out to avoid being tracked and provided personalized content from the embedded content provider or redirector environment. However, even with these schemes, when the user is tracked, it can be done by a single entity that collects the user's information from all the websites and web pages visited by the user that display embedded content using the same embedded content provider.

In contrast, the tools and techniques described herein can typically shield such identifying information from the embedded content provider or advertisement redirector. This can be done with a small effect on performance, typically only including one additional transmission through a delegate or broker computing environment.

The subject matter defined in the appended claims is not necessarily limited to the benefits described herein. A particular implementation of the invention may provide all, some, or none of the benefits described herein. Although operations for the various techniques are described herein in a particular, sequential order for the sake of presentation, it should be understood that this manner of description encompasses rearrangements in the order of operations, unless a particular ordering is required. For example, operations described sequentially may in some cases be rearranged or performed concurrently. Techniques described herein with reference to flowcharts may be used with one or more of the systems described herein and/or with one or more other systems. Moreover, for the sake of simplicity, flowcharts may not show the various ways in which particular techniques can be used in conjunction with other techniques.

### I. Exemplary Computing Environment

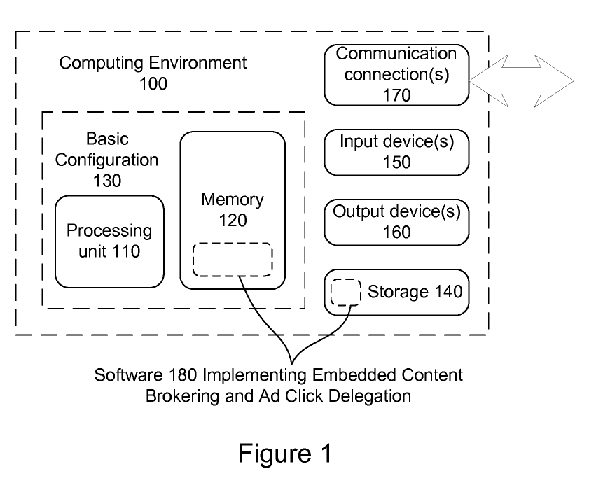

FIG. 1 illustrates a generalized example of a suitable computing environment (100) in which one or more of the described embodiments may be implemented. For example, one or more such computing environments can be used as a client environment, digital document publisher environment, digital document provider environment, embedded content provider environment, advertisement selection delegate environment, advertisement redirector environment and/or advertiser environment. Generally, various different general purpose or special purpose computing system configurations can be used. Examples of well-known computing system configurations that may be suitable for use with the tools and techniques described herein include, but are not limited to, server farms and server clusters, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

The computing environment (100) is not intended to suggest any limitation as to scope of use or functionality of the invention, as the present invention may be implemented in diverse general-purpose or special-purpose computing environments.

With reference to FIG. 1, the computing environment (100) includes at least one processing unit (110) and memory (120). In FIG. 1, this most basic configuration (130) is included within a dashed line. The processing unit (110) executes computer-executable instructions and may be a real or a virtual processor. In a multi-processing system, multiple processing units execute computer-executable instructions to increase processing power. The memory (120) may be volatile memory (e.g., registers, cache, RAM), non-volatile memory (e.g., ROM, EEPROM, flash memory), or some combination of the two. The memory (120) stores software (180) implementing embedded content brokering and advertisement selection delegation.

Although the various blocks of FIG. 1 are shown with lines for the sake of clarity, in reality, delineating various components is not so clear and, metaphorically, the lines of FIG. 1 and the other figures discussed below would more accurately be grey and fuzzy. For example, one may consider a presentation component such as a display device to be an I/O component. Also, processors have memory. The inventors hereof recognize that such is the nature of the art and reiterate that the diagram of FIG. 1 is merely illustrative of an exemplary computing device that can be used in connection with one or more embodiments of the present invention. Distinction is not made between such categories as “workstation,” “server,” “laptop,” “handheld device,” etc., as all are contemplated within the scope of FIG. 1 and reference to “computer,” “computing environment,” or “computing device.”

A computing environment (100) may have additional features. In FIG. 1, the computing environment (100) includes storage (140), one or more input devices (150), one or more output devices (160), and one or more communication connections (170). An interconnection mechanism (not shown) such as a bus, controller, or network interconnects the components of the computing environment (100). Typically, operating system software (not shown) provides an operating environment for other software executing in the computing environment (100), and coordinates activities of the components of the computing environment (100).

The storage (140) may be removable or non-removable, and may include magnetic disks, magnetic tapes or cassettes, CD-ROMs, CD-RWs, DVDs, or any other medium which can be used to store information and which can be accessed within the computing environment (100). The storage (140) stores instructions for the software (180).

The input device(s) (150) may be a touch input device such as a keyboard, mouse, pen, or trackball; a voice input device; a scanning device; a network adapter; a CD/DVD reader; or another device that provides input to the computing environment (100). The output device(s) (160) may be a display, printer, speaker, CD/DVD-writer, network adapter, or another device that provides output from the computing environment (100).

The communication connection(s) (170) enable communication over a communication medium to another computing entity. Thus, the computing environment (100) may operate in a networked environment using logical connections to one or more remote computing devices, such as a personal computer, a server, a router, a network PC, a peer device or another common network node. The communication medium conveys information such as data or computer-executable instructions or requests in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The tools and techniques can be described in the general context of computer-readable media. Computer-readable media are any available media that can be accessed within a computing environment. By way of example, and not limitation, with the computing environment (100), computer-readable media include memory (120), storage (140), and combinations of the above.

The tools and techniques can be described in the general context of computer-executable instructions, such as those included in program modules, being executed in a computing environment on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing environment. In a distributed computing environment, program modules may be located in both local and remote computer storage media.

For the sake of presentation, the detailed description uses terms like “determine,” “select,” “send,” and “receive” to describe computer operations in a computing environment. These and other similar terms are high-level abstractions for operations performed by a computer, and should not be confused with acts performed by a human being, unless performance of an act by a human being (such as a “user”) is explicitly noted. The actual computer operations corresponding to these terms vary depending on the implementation.

### II. Systems and Techniques for Embedded Content Brokering and Advertisement Selection Delegation

Embedded content brokering and advertisement selection delegation systems and techniques will now be described. The computing environments referred to in the descriptions of such systems and techniques can be computing environments having components such as those described above with reference to FIG. 1. The different environments can be connected over a computer network, such as a global computer network (e.g., the Internet). In addition, the described messages (requests, content messages, digital document messages, redirect messages, etc.) can be appropriate messages sent in any of various available formats (e.g., HTTP messages) over such a global computer network or some other network.

A. Embedded Content Brokering Systems and Techniques

Various examples of embedded content brokering systems and techniques will now be described.

1. Digital Document Provider Acting as the Embedded Content Broker

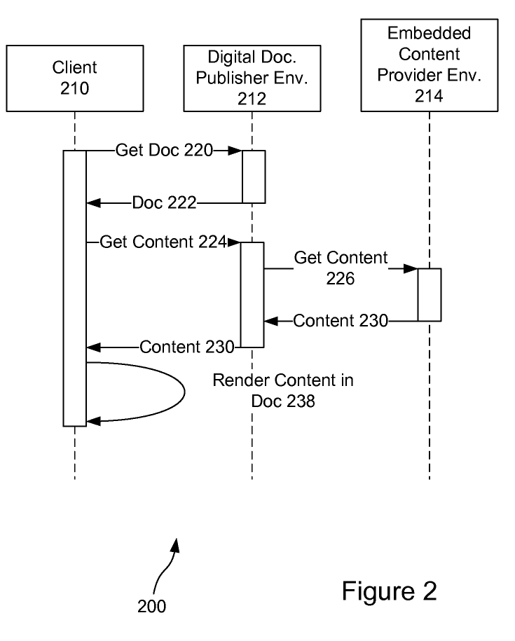

Referring now to FIG. 2, an embedded content brokering system (200) and associated techniques will now be described, where the same environment acts as a digital document publisher environment and an embedded content broker environment. The embedded content brokering system (200) can include a client computing environment (210), a digital document publisher computing environment (212) (which also acts as an embedded content broker environment), and an embedded content provider environment (214).

The client computing environment (210) can send a digital document request (220) to the publisher environment (212). The digital document request (220) can list an address associated with the publisher environment (212) as a final destination for the digital document request (220). For example, the digital document request (220) may be an HTTP get request that lists a URL for a web page hosted by the publisher environment (212), where the hosted web page is the requested digital document. The publisher environment (212) may be a web server environment that provides digital documents such as HTML documents over a global computer network, such as the Internet. The publisher environment (212) can return the digital document (222) in a response message to the client environment (210).

The digital document (222) can include an embedded content placeholder, which can trigger the client environment (210) to send a client embedded content request (224) to the publisher environment (212). For example, the digital document (222) can include a script that can be executed by the client environment (210) to send the client embedded content request (224).

The publisher environment (212) can receive the embedded content request (224) and identify and remove identifying information corresponding to the client environment (210) (e.g., user name information for users of the client environment (210), network address of the client environment (210), etc.) from the request. The publisher environment (212) can then send a third-party embedded content request (226) to an embedded content provider environment (214), and can omit the identifying information from the third-party embedded content request (226). The client computing environment (210) can also send a user profile separately or as part of the client embedded content request (224). The publisher environment (212) can also forward the user profile to the embedded content provider environment (214), thereby allowing the embedded content provider environment (214) to return personalized content.

Upon receiving the third-party embedded content request (226), the embedded content provider environment (214) can return the requested content (230) to the publisher environment (212). The publisher environment (212) can forward the content (230) to the client environment (210). To facilitate forwarding of the content (230), the publisher environment (212) can maintain information, such as an identifier, that links the third-party embedded content request (226) and the returned message including the content (230) with the client environment (210). This forwarding may be done in the same way as is done by many existing proxy computing environment. For example, the publisher environment (212) can remember a first port in which the client computing environment (210) requested the content, and a second port in which the content (230) is expected to be received back from the content provider environment (214). Thus, when the content (230) is received from the embedded content provider environment (214) in the second port, the publisher environment (212) can forward the content (230) on to the first port so that it will be sent to the client environment (210). The other brokering and delegate environments discussed below can correspond with client environments and content provider or advertisement redirector environments in similar ways, or using other schemes for proper forwarding of messages.

The content (230) can be received by the client environment (210), embedded in the digital document (222), and rendered (238) along with the digital document (222) (i.e., representations of the embedded content and the digital document can be displayed on a computer display). For example, if the digital document is an HTML page, and the embedded content includes advertisements, then the advertisements can be rendered on a computer display as part of the HTML page content.

2. Digital Document Provider Separate from the Embedded Content Broker

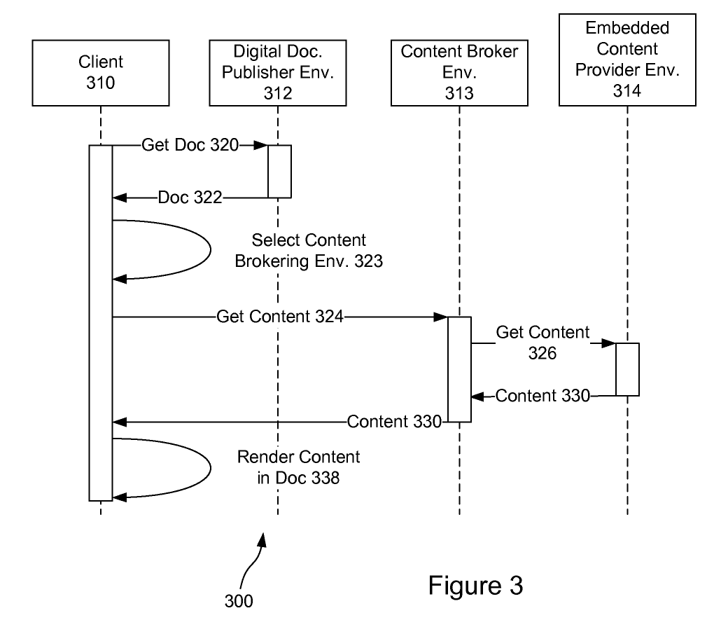

Referring now to FIG. 3, another embedded content brokering system (300) and associated techniques will be described, where a digital document provider or publisher environment is separate from an embedded content broker environment. The embedded content brokering system (300) can include a client computing environment (310), a digital document publisher computing environment (312), a content broker computing environment (313), and an embedded content provider computing environment (314).

A digital document request (320) can be sent from the client environment (310) to the publisher environment (312). In response, the publisher environment (312) can return a digital document (322) to the client environment (310). Upon receiving the document (322), the client environment (310) can render or display the digital document (322) on a computer display. The digital document (322) can include an embedded content placeholder.

In response to receiving the digital document (322) with the placeholder, the client environment (310) can select (323) a content broker environment (313) from among multiple available content broker environments to assist in obtaining embedded content corresponding to the placeholder in the digital document (322). For example, the client environment (310) may receive a list of available content broker environments and display that list on a computer display. The client environment (310) can receive user input selecting a content broker environment (313) from the list. As another example, the client environment (310) can automatically select a content broker environment (313), such as by randomly selecting the content broker environment (313) from a list of available content broker environments.

The client environment (310) can send a client content request (324) to the selected content broker environment (313). The client content request (324) can include a user profile to assist in personalizing the selected content, or such a user profile can be sent separately (not shown). The content broker environment (313) can remove identifying information from the client content request (324), and can send a broker embedded content request (326) to the content provider environment (314), with the identifying information omitted. However, a user profile may be sent with the broker embedded content request (326) to assist the content provider environment (314) in providing personalized content. In response to the broker embedded content request (326), the content provider environment (314) can return content (330) to the content broker environment (313). The content broker environment (313) can forward the content (330) on to the client environment (310). The client environment (310) can then render (338) the content (330) in the digital document (322).

3. Providing Embedded Content to the Client with the Requested Document

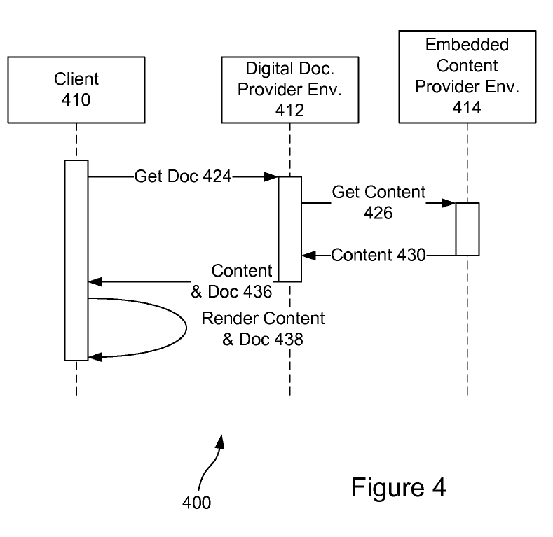

Referring now to FIG. 4, yet another embedded content brokering system (400) and associated techniques will be described, where the embedded content can be provided to the client environment along with the digital document, such as by sending a web page with embedded advertisements already included in the page. The embedded content brokering system (400) can include a client computing environment (410), a digital document provider environment (412), and an embedded content provider environment (414).

A client digital document request (424) can be sent from the client environment (410) to the digital document provider environment (412). The client digital document request (424) may include a user profile. For example, the user profile may be included in a cookie that is associated with the digital document provider environment (412), and client environment (410) may send the cookie along with the client digital document request (424) in a standard manner.

Rather than immediately returning a requested digital document, the digital document provider environment (412) can request embedded content by sending an embedded content request (426) to the embedded content provider environment (414). The embedded content request (426) can include the user profile to assist the embedded content provider environment (414) in providing personalized embedded content (430). The embedded content provider environment (414) can return the content (430) to the digital document provider environment (412). The digital document provider environment (412) can include the content (430) in a packet (436) with the requested digital document, and can send the packet (436) to the client environment (410). The packet by include separate files for the digital document and the content (430), or the content (430) may be included in a file as part of the digital document. The content and digital document can then be rendered (438) on a computer display at the client environment (410).

B. Advertisement Selection Delegation Systems and Techniques

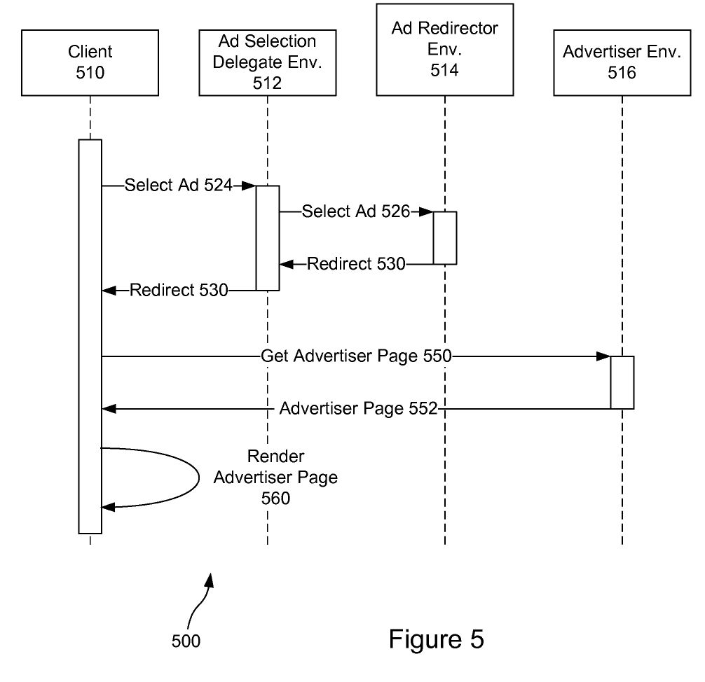

Referring now to FIG. 5, an example of an advertisement selection delegation system (500) and associated techniques will be described. The advertisement selection delegation system (500) can include a client environment (510), which can be the same as one of the client environments discussed above with reference to FIGS. 2-4 or some other environment. The advertisement selection delegation system (500) can also include an advertisement selection delegate environment (512), which can be the same as the digital document publisher environment (212) of FIG. 2, the content broker environment (313) of FIG. 3, or the digital document provider environment (412) of FIG. 4. Alternatively, the advertisement selection delegate environment (512) can be some other environment. The advertisement selection delegation system (500) can also include an advertisement redirector environment (514), which can be the same as the embedded content provider environment (214) of FIG. 2, the embedded content provider environment (314) of FIG. 3, or the embedded content provider environment (414) of FIG. 4. Alternatively, the advertisement redirector environment (514) can be some other environment. In addition, the advertisement selection delegation system (500) can include an advertiser environment (516).

The client environment (510) can receive user input selecting an advertisement, such as an embedded advertisement that is part of the embedded content (230, 330, or 430) of FIG. 2, FIG. 3, or FIG. 4. For example, the user input could result from a user hovering a cursor over such an advertisement and clicking a mouse or keyboard button. In response to the user input, the client environment (510) can send a client advertisement selection message (524) to an advertisement selection delegate environment (512). The advertisement selection delegate environment (512) can identify and remove identifying information corresponding to the client environment (510) from the client advertisement selection message (524). The advertisement selection delegate environment (512) can forward a delegate advertisement selection message (526) to the advertisement redirector environment (514), with the identifying information omitted.

The advertisement redirector environment (514) can return a redirect message (530) to the advertisement selection delegate environment (512), and the advertisement selection delegate environment (512) can forward the redirect message (530) to the client environment (510). The redirect message (530) can include an address identifier such as a URL associated with the advertiser environment (516).

Upon receiving the redirect message (530), the client environment (510) can send an advertiser page request (550) to the advertiser environment (516), and the advertiser environment (516) can return an associated advertiser page (552), which can be a digital document, such as an HTML file. The client environment can render (560) the advertiser page (552) on a computer display in the client environment (510).

### III. User Profiles and Client-Centered User Classification

The user profiles referred to herein may be user profiles that are non-obfuscated and that are generated using unfiltered information. However, in some implementations the user profiles may be filtered and/or obfuscated, such as by using the techniques and tools described in this section. Such techniques and tools may include collecting unfiltered user input information about user input actions at the client computing environment. That user input information may be stored in one or more storage devices in the client computing environment, and the information can be classified to create a user profile. However, the unfiltered (i.e., not yet filtered to exclude personal information) user input information can be filtered before being classified so that personal information can be excluded from use in the classification.

The profile can be sent to a server-side service so that the service can provide personalized content, such as targeted advertisements, to the user. Thus, the server-side service does not have access to the user's user input information. Moreover, the personal information can be excluded from the classification so that the user profile will not reflect the personal information. In addition to or instead of filtering personal information from the user input information, the user profile can be obfuscated (such as by including fake user segment correlations in the profile) to mask the user's true profile from the server-side service, and the user's computing environment can de-obfuscate personalized content (such as by removing content that corresponds to the fake user segment correlations) received from the service before presenting the content to the user. Despite these privacy protections, the service can still provide personalized content to the user. Accordingly, the server-side service may have a decreased motivation to track the user. Indeed, the server-side service may agree to abstain from tracking the user in exchange for the user providing the user profile upon request.

As used herein, a user input action includes one or more actions input by a user through one or more user input devices to trigger an event in a computing environment. A user input action can also result in a message (e.g., a HTTP message) being passed to some other computing environment, such as a message sent over a global computer network. For example, user input actions could include actions resulting from using a keyboard to enter a search string to be passed to a search engine over a global computer network, or using a mouse to position a cursor over a displayed hyperlink and clicking on the hyperlink to navigate to an associated webpage. User input actions can be represented by user input information, which can include user action representations, such as tuples indicating events triggered by user input actions (e.g., {Navigation, http://www.msn.com, 9/9/08 8:30 am}; {Search, ‘fast cars’, 9/9/08 8:30 am}).

A user profile is a representation of one or more characteristics of a user or group of users (e.g., if two or more users are using the same user account in a computing environment). Classification refers to the use of user input information to create a user profile, which can include updating an existing user profile or creating a new user profile. For example, classification can include applying a set of segment rules to user input information to create a user profile that correlates the user with a set of one or more segments or categories defined by the segment rules.

A user profile can include assignments to one or more segments. For example, a segment rule can dictate that if the user searches for “wm6” or “Zune” then the user is part of a “gadget seeker” segment. In addition to or instead of such assignments, a user profile can also provide probabilities of the associated user input information correlating to one or more segments. Such probabilities can be expressed in any way that represents the likelihood of the correlation, and such probabilities are not limited to strict statistical probabilities. For example, a segment rule can dictate that if the user searched using automobile-related terms (Ford, Chevrolet, Toyota, Porsche, automobile, etc.) in the last thirty days, then there is a probability of the user profile correlating to a “car lover” segment, with the probability increasing with the number of such terms that are entered. For example, the probability could be represented by a percentage equal to the number of automobile-related terms multiplied by ten, up to a maximum of one-hundred.

The techniques can also include filtering or excluding personal information from use in classification. Personal information is information whose use in classification is limited, such as by sensitivity rules resulting from limiting user input and/or from some other source such as a rules server. For example, sensitivity rules can be received from a server over a global communications network. By way of example, personal information can include personal identifiable information (PII), which is information that can be used by itself or in combination with other available information to identify a particular user. However, some such information may not be defined as personal information in a particular set of sensitivity rules. In addition, personal information can include other information defined by the sensitivity rules, such as information the particular user does not want to share. For example, a user might enter a limiting user input indicating that the user does not want to share user input information including the word “soccer” if the user does not want to share the fact that the user is interested in soccer.

Sensitivity rules can include sensitive user action rules, which can each define one or more personal user action representations that reveal personal information without reference to other user action representations. For example, sensitive user action rules can define user action representations that include words or phrases that reveal PII (name, credit card number, user name, address, etc.), and/or that indicate particular religious affiliations, diseases, or adult-only subject matter. Sensitive user action rules may be installed as a set of rules in a client computing environment, and/or they can be created or altered by a user at the client computing environment.

Sensitivity rules can also include sensitive inference rules, which can each define a pattern of user action representations that reveal personal information when taken together. For example, one such rule could dictate that if a user searches for “stomach ache” and soon after searches for “worms,” then delete both of the corresponding user action representations (or delete one of them). As with sensitive user action rules, sensitive inference rules may be installed as a set of rules in a client computing environment, and/or they can be created or altered by a user at the client computing environment.

While the sensitivity rules can dictate that personal information is to be filtered or excluded from use in classification, this can be done in different ways. For example, the personal information can be ignored by a classification module, deleted, quarantined (e.g., stored separately from information used in classification or flagged to be excluded from classification), or generalized. As an example of generalization, if a user entered “Ford” and that was considered to be personal information, then “Ford” could be replaced with “automobile” in a user action representation. Thus, the personal information (Ford) could be filtered out, but some corresponding useful information (automobile) could still be used in classification.

The user input information can be stored in one or more storage devices in the user's computing environment, as can a user profile created by classifying the user input information. When a remote computing environment desires to have the user profile to target the user with personalized information, the user's computing environment can send the profile to the remote computing environment. Accordingly, the user input information can be controlled by the user. In addition, the user can still receive the benefits of targeted information from the remote computing environment. The user could take additional steps to remain anonymous with respect to the remote computing environment, such as by using an anonymous network (e.g., an anonymous network using onion routing). As another alternative, the user could remain somewhat anonymous to some or all remote computing environments by having multiple trusted third party computing environments act as proxies or brokers between the user's computing environment and the remote computing environment(s).

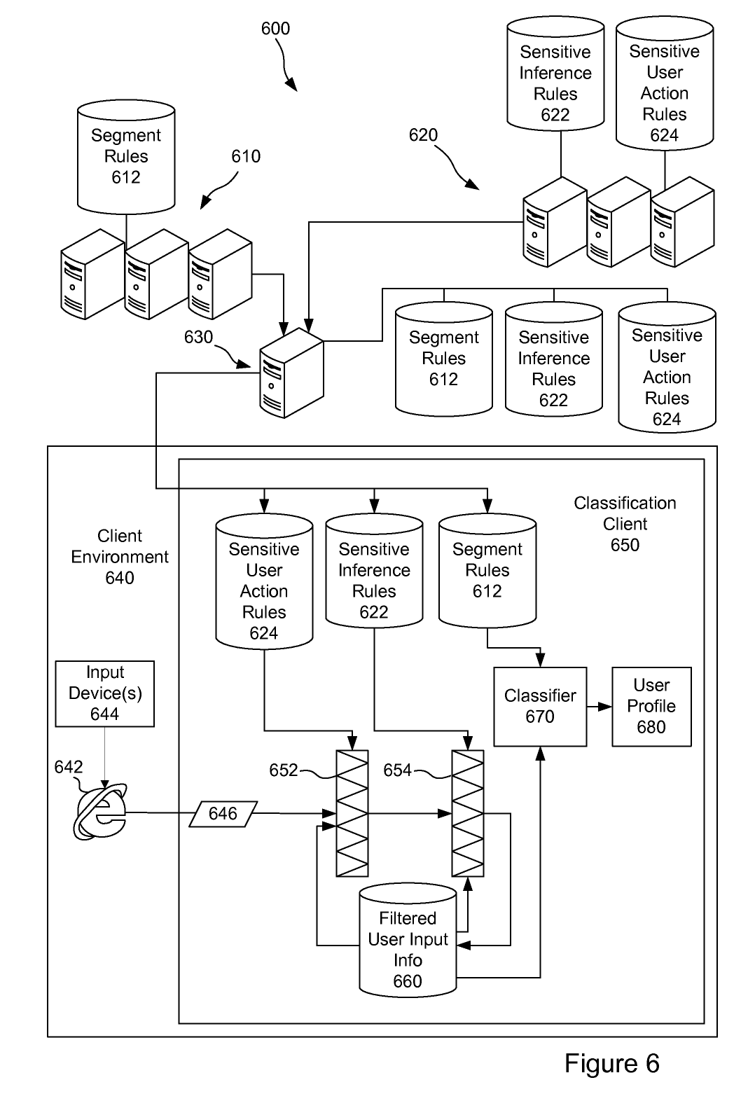

FIG. 6 is a block diagram of a client-centered usage classification system (600). The classification system (600) can include a segment rules source (610), which can be a computing environment where segment rules (612) are generated and stored in one or more storage devices, such as those described above with reference to FIG. 1.

The classification system (600) can also include a sensitivity rules source (620). The sensitivity rules source (620) can be a computing environment where sensitivity rules, such as sensitive inference rules (622) and sensitive user action rules (624) can be generated and stored in one or more storage devices, such as those described above with reference to FIG. 1.

The classification system (600) can also include a rules server (630), which can be a computing environment that receives the segment rules (612) from the segment rules source (610) and receives the sensitivity rules (622 and 624) from the sensitivity rules source (620) and stores those rules (612, 622 and 624) in one or more storage devices, such as those described above with reference to FIG. 1.

The rules server (630) can send the rules (612, 622, and 624) to a client computing environment (640), which can also be part of the classification system (600). The rules (612, 622, and 624) can be stored in one or more storage devices in the client computing environment (640).

The client computing environment (640) can include one or more input devices (644), such as those described above with reference to FIG. 1. The input device(s) (644) can provide user input actions, which can be processed by the client environment (640) to trigger actions by one or more applications (642), such as one or more browser applications, to perform an action indicated by the user input. For example, the application (642) can request a digital document over a global computer network in a standard manner, such as by sending a HTTP message triggering a search or requesting a particular webpage. The application (642) can pass unfiltered user input information (646) to a classification client (650), which can be a client module that classifies user input information (646). The classification client (650) can be a stand-alone application, or it can be part of one or more other applications, such as a browser application (e.g., Internet Explorer® internet browser, etc.).

The classification client (650) can pass incoming information through a sensitive user action filter (652), which can access and apply the sensitive user action rules (624) to remove personal user input information described by those rules from the unfiltered user input information (646). The classification client (650) can then pass user input information that has not been removed by the sensitive user action filter (652) to a sensitive inference filter (654). The sensitive inference filter (654) can also access filtered user input information (660) that has already been stored in one or more storage devices in the client environment (640), and can access the sensitive inference rules (622) to identify and remove patterns of user input information that can reveal personal information, as defined by the sensitive inference rules (622). The resulting filtered information can be stored with the existing filtered user input information (660) in one or more storage devices in the client environment (640), such as the types of storage devices described above with reference to FIG. 1.

The sensitivity rules (622 and 624) can be updated as newer versions are received from the rules server (630) and/or sensitivity rules are added, deleted, or modified by a user providing input through a user input device at the client environment (640). For example, the client can check for updates from the rules server (630) according to a schedule or when directed to do so by user input. When the sensitivity rules (622 or 624) are updated (and/or according to a schedule, and/or according to some other scheme), the classification client (650) can feed the stored filtered user input information (660) back through the filters (652 and 654) and store the resulting filtered information. In this way, the classification client (650) can filter out existing user input information that did not constitute personal information according to the sensitivity rules (622 and 624) prior to the rules (622 and 624) being updated, but does constitute personal information according to one or more of the sensitivity rules (622 and 624) after the rules (622 and 624) are updated.

The classification client (650) can also include a classifier (670), which can classify the filtered user input information (660). For example, the classifier (670) can determine whether the filtered user input information (660) corresponds to the segments of the segment rules (612). If so, then the classifier (670) can include one or more correlations to corresponding segments in a user profile (680). For example, the correlations can be assignments to corresponding segments (e.g., the user profile can include a listing of segments to which the filtered user input information (660) corresponds). The correlations can also include probabilities that the filtered user input information (660) corresponds to the corresponding segments (e.g., the user profile (680) can include a listing of segments with each segment including a corresponding numerical indicator of the probability that the user input information corresponds to the segment). The user profile (680) can be stored in one or more storage devices in the client environment (640).

The user profile (680) can be passed to one or more server environments (not shown) so that the server environment(s) can provide personalized content to the client environment (640). For example, the personalized content could be personalized advertisements, website news content, RSS feeds, etc.

The filtering and classification can be done in ways other than those described above. For example, the user input information (646) can be stored without being filtered, and it can be filtered as it is passed from storage to the classifier (670). However, storing the user input information (646) without filtering the information first may cause privacy concerns for some users.

The segment rules source (610) can send segment rules discovery queries to the client environment (640) via the rules server (630). These discovery queries can be similar in format to the segment rules (612). The discovery queries may not be stored in a persistent state in the client environment (640), while the rules (612, 622, and 624) typically can be stored in a persistent state in the client environment (640). In addition, the discovery queries can trigger the client environment (640) to immediately classify the filtered user input information (660), produce a segment discovery user profile including correlations to corresponding new tentative segments, and send the segment discovery user profile to the segment rules source (610). The segment rules source (610) can use the segment discovery user profile in determining whether to include the new tentative segments indicated by the discovery query as segments indicated by the segment rules (612). For example, the segment rules source (610) can determine whether enough user profiles correlate to a tentative segment to include a corresponding segment rule in the regular set of segment rules (612).

The segment rules source (610), the sensitivity rules source (620), and the rules server (630) can all be a server computing environments that are connected to one or more computer networks, such as a global computer network (for example, the Internet). Messages and associated data (e.g., rules (612, 622 and 624)) sent between the segment rules source (610), the sensitivity rules source (620), the rules server (630), and the client environment (640) can be sent in standard ways, such as sending HTTP or FTP messages over a global computer network. Of course, other ways of communicating between the various computing environments are also possible. In addition, the roles of the rules sources (610 and 620) and the rules server (630) could all be performed by a single computing environment or by some different combination of computing environments.

### IV. Embedded Content Brokering and Advertisement Selection Delegation Techniques

The techniques discussed below can be used with the computing environments and system(s) discussed above or with some other computing environment(s) or system(s). In addition, the techniques discussed below, and those discussed above, may be repeated and/or used together in some implementations. For example, the techniques can be repeated with different publisher environments, broker environments, and/or delegate environments when subsequent digital documents and/or advertisement selections are received at a client environment.

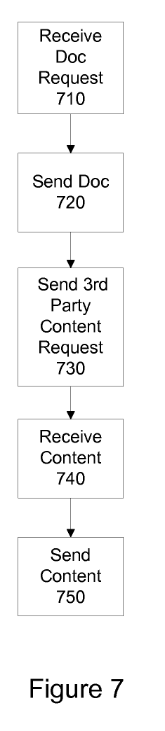

Referring to FIG. 7, a content brokering technique will be discussed, where a publisher environment can act as a broker environment. The technique can include receiving (710) a client digital document request, such as receiving such a request at a publisher computing environment from a client computing environment. The technique can also include sending (720) a requested digital document to the client computing environment. The technique can also include sending (730) a third-party content request, such as sending such a request from the publisher environment to a content provider computing environment, possibly after omitting from the third-party content request identifying information corresponding to the client environment. The requested content can be received (740) from the content provider environment at the publisher environment. The publisher environment can then send (750) the content to the client environment.

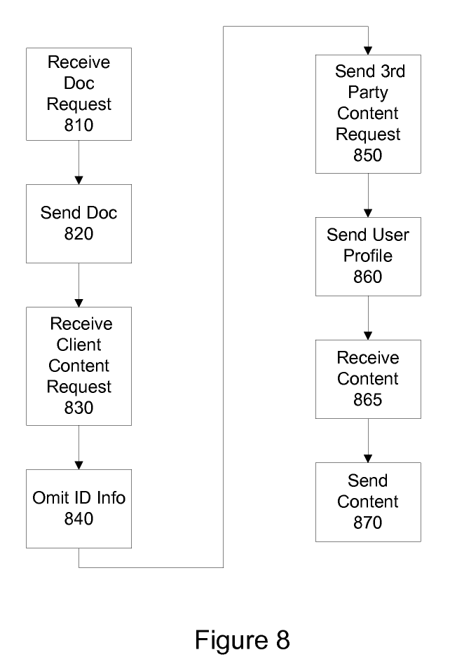

Referring now to FIG. 8, another content brokering technique will be described. In the technique of FIG. 8, a document request can be received (810). For example, the document request can be a request sent from a client computing environment to a publisher computing environment. The requested document can be sent (820) from the publisher environment to the client environment. A client content request can be received (830) from the client environment at the publisher environment. Identifying information corresponding to the client environment can be omitted (840) from the client content request, and a resulting third-party content request without the identifying information can be sent (850) to a content provider environment. A user profile may also be sent (860) from the publisher environment to the content provider environment. Such a user profile may have been received at the publisher environment from the client environment. Content requested by the third-party content request can be received (865) from the content provider environment at the publisher environment, and the content can be sent (870) from the publisher environment to the client environment. The content can then be rendered along with the digital document at the client computing environment.

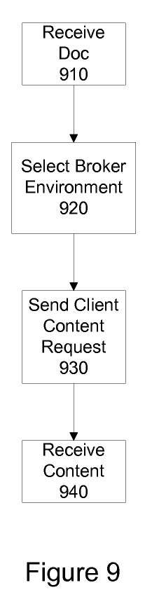

Referring to FIG. 9, yet another content brokering technique will be described, where a broker environment can be selected from among multiple available broker environments. The technique can include receiving (910) a digital document, such as receiving a digital document from a publisher environment at a client environment. A broker environment can be selected (920). For example, a broker environment can be selected (920) by the client environment from among multiple available broker environments. A client embedded content request can be sent (930) to the selected broker environment, and that broker environment can act as a broker to obtain the requested content and send it back to the client environment. The client environment can receive (940) the embedded content from the broker environment. The client environment can then render the content on a computer display in the client environment.

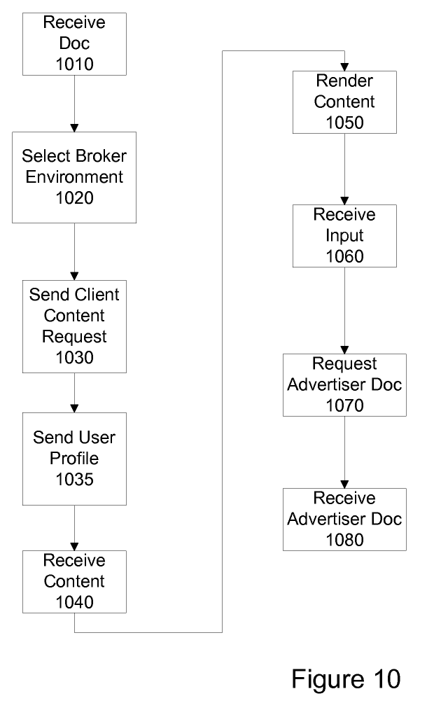

Referring to FIG. 10, yet another content brokering technique will be described, where a broker computing environment is selected from among multiple available broker environments, and where an advertiser document is requested. The technique can include receiving (1010) a digital document, which can include a placeholder for embedded content. A broker environment can be selected (1020) from multiple available broker environments by the client environment. The client environment can send (1030) a client embedded content request to the selected broker environment. The client environment can also send (1035) a user profile to the selected broker environment.

The selected broker environment can forward the content request (typically after omitting identifying information corresponding to the client environment) and the user profile to an embedded content provider environment. The embedded content provider environment can return content, which may be personalized according to the user profile, to the selected broker environment. The broker environment can forward the content to the client environment. The client environment can receive (1040) the content and render (1050) the content along with the received digital document.

The client environment may also receive (1060) user input selecting at least a portion of the content, such as user input selecting an advertisement within the content. In response to the user input, the client environment can request (1070) an advertiser digital document, such as by sending a request message to an advertiser computing environment. The client can also receive (1080) the advertiser document, and can render the advertiser document on a display in the client environment.

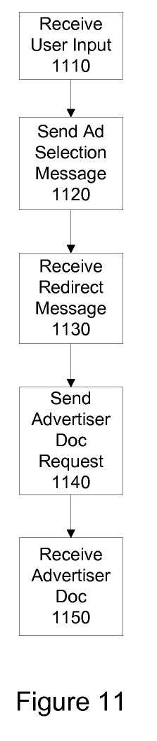

FIG. 11 is a flow diagram of an advertisement selection delegation technique. The technique can include receiving (1110) user input at a client computing environment, wherein the user input selects an advertisement. For example, the advertisement may be an embedded advertisement that is part of the content discussed above with reference to content brokering techniques. An advertisement selection message can be sent (1120) from the client environment to an advertisement selection delegate environment. The advertisement selection delegate environment can obtain a redirect message corresponding to the advertisement selection message from an advertisement redirector environment, and can forward the redirect message to the client environment. Upon receiving (1130) the redirect message, the client environment can send (1140) an advertiser document request to an advertiser computing environment. Finally, the client environment can receive (1150) an advertiser document from the advertiser environment. The client environment can also render the advertiser document on a computer display in the client environment.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

I/We claim:

1. One or more computer-readable media having computer-executable instructions embodied thereon that, when executed, perform acts comprising:
receiving at a publisher computing environment a digital document request from a client computing environment, the digital document request listing an address associated with the publisher computing environment as a final destination for the digital document request, and the digital document request requesting a digital document comprising an embedded content placeholder;
sending a third-party embedded content request from the publisher computing environment to an embedded content provider computing environment, the third-party embedded content request requesting content for the embedded content placeholder;
receiving content corresponding to the third-party embedded content request at the publisher computing environment;
sending the digital document from the publisher computing environment to the client computing environment; and
sending the content from the publisher computing environment to the client computing environment.

2. The one or more computer readable media of claim 1, wherein:
the acts further comprise receiving a client embedded content request from the client computing environment at the publisher computing environment after sending the digital document from the publisher computing environment to the client computing environment; and
sending the third-party embedded content request comprises sending the third-party embedded content request in response to receiving the client embedded content request at the publisher computing environment.

3. The one or more computer readable media of claim 2, wherein:
the client computing environment, the publisher computing environment, and the embedded content provider computing environment are connected to a global computer network;
sending the third-party embedded content request, sending the digital document, and sending the content all comprise transmitting data over the global computer network;
the content comprises one or more digital advertisements; and
the third-party embedded content request comprises a user profile received by the publisher computing environment from the client computing environment, the user profile comprising a representation of one or more characteristics of a user or group of users of the client computing environment;
the client embedded content request comprises identifying information associated with the client computing environment; and
the acts further comprise omitting the identifying information from the third-party embedded content request.

4. The one or more computer readable media of claim 2, wherein the client embedded content request comprises identifying information associated with the client computing environment, and the acts further comprise omitting the identifying information from the third-party embedded content request.

5. The one or more computer readable media of claim 1, wherein the acts further comprise sending the digital document and the content together from the publisher computing environment to the client computing environment.

6. The one or more computer readable media of claim 1, wherein the content comprises one or more digital advertisements.

7. The one or more computer readable media of claim 1, wherein the acts further comprise sending a user profile from the publisher computing environment to the embedded content provider computing environment.

8. A computer-implemented method comprising:
receiving a digital document at a client computing environment;
at the client computing environment, selecting a content broker computing environment from a plurality of available content broker computing environments, each of the available content broker computing environments being configured to:
receive client embedded content requests;
in response to the client embedded content requests, send broker embedded content requests to an embedded content provider computing environment; and
receive content requested by the third-party embedded content requests;
sending a client embedded content request from the client computing environment to the selected content broker computing environment;
receiving from the selected content broker computing environment content requested in the client embedded content request; and
rendering the content requested in the client embedded content request along with the digital document on a display at the client computing environment.

9. The method of claim 8, wherein the digital document is a first digital document, the selected content broker computing environment is a first content broker computing environment, the client embedded content request is a first client embedded content request, and wherein the method further comprises:
receiving a second digital document at the client computing environment;
at the client computing environment, selecting a second content broker computing environment from the plurality of available content broker computing environments;
sending a second client embedded content request from the client computing environment to the second content broker computing environment;
receiving from the second content broker computing environment content requested in the second client embedded content request; and
rendering the content requested in the second client embedded content request with the second digital document on the display at the client computing environment.

10. The method of claim 8, wherein selecting the content broker computing environment comprises receiving user input selecting the content broker computing environment.

11. The method of claim 8, wherein selecting the content broker computing environment comprises automatically selecting the content broker computing environment.

12. The method of claim 8, each of the available content broker computing environments is configured to:
receive the client embedded content requests, the client embedded content requests including identifying information associated with client computing environments that send the client embedded content requests; and
omit the identifying information from the third-party embedded content requests.

13. The method of claim 8, wherein the content comprises one or more digital advertisements, and wherein the method further comprises:
receiving user input selecting a selected advertisement of the one or more advertisements;
transmitting to an advertiser computing environment a request for a digital advertiser document associated with the selected advertisement; and
at the client computing environment, receiving the digital advertiser document from the advertiser computing environment.

14. The method of claim 8, further comprising sending a user profile from the client computing environment to the content broker computing environment.

15. A client computer system comprising:
means for receiving user input selecting a displayed digital advertisement;
means for sending a client advertisement selection message to an advertisement selection delegate computing environment, the advertisement selection delegate computing environment being configured to:
receive client advertisement selection messages;
in response to receiving the advertisement selection messages, forward corresponding delegate advertisement selection messages to an advertisement redirector computing environment; and
receive from the advertisement redirector computing environment redirect messages corresponding to the delegate advertisement selection messages;
means for receiving a redirect message from the advertisement selection delegate computing environment in response to the client advertisement selection message, the redirect message comprising an address indicator corresponding to an advertiser computing environment;
means for sending an advertiser document request to the advertiser computing environment in response to receiving the redirect message, the advertiser document request not being addressed to the advertisement selection delegate computing environment; and
means for receiving a digital advertiser document corresponding to the advertiser document request.

16. The computer system of claim 15, wherein the advertiser document request is not sent to the advertisement selection delegate computing environment.

17. The computer system of claim 15, further comprising:
means for receiving a digital document at the client computing environment from a digital document provider computing environment;
means for sending a client advertisement request from the client computing environment to an advertisement broker computing environment, the advertisement broker computing environment being configured to:
receive client advertisement requests;
in response to the client advertisement requests, send broker advertisement requests to an advertisement provider computing environment; and
receive advertisements requested in the third-party advertisement requests; and
means for receiving from the advertisement broker computing environment one or more advertisements requested in the client advertisement request.

18. The computer system of claim 17, wherein the displayed digital advertisement is one of the one or more advertisements requested in the client advertisement request.

19. The computer system of claim 17, wherein the advertisement broker computing environment and the advertisement selection delegate computing environment are the same computing environment, and wherein the advertisement redirector computing environment and the advertisement provider computing environment are the same computing environment.

20. The computer system of claim 17, wherein advertisement selection delegate computing environment is configured to:
receive the client advertisement selection messages, the client advertisement selection messages including identifying information associated with client computing environments that send the advertisement selection messages; and
omit the identifying information from the delegate advertisement selection messages.
